(19) United States
(12) Patent Application Publication
(10) Pub. No.: US 2025/0303428 A1
(43) Pub. Date: Oct. 2, 2025

(54) SPINNER TIP

(71) Applicant: Dig Pig Products Inc., Stettler (CA)

(72) Inventors: Robert C. Rajewski, Stettler (CA); Cal Robert Rajewski, Donalda (CA)

(73) Assignee: Dig Pig Products Inc., Stettler, AB (CA)

(21) Appl. No.: 18/879,206

(22) PCT Filed: Jun. 30, 2023
(86) PCT No.: PCT/CA2023/050905

§ 371 Date: Dec. 26, 2024

Related U.S. Application Data
(60) Provisional application No. 63/357,598, filed on Jun. 30, 2022.

(51) Int. Cl. B05B 3/04

(52) U.S. Cl. CPC B05B 3/0463

(57) ABSTRACT

There is provided a spinner tip for hydrovacing or hydro blasting. The spinner tip comprises an inlet. The inlet has an inlet housing and a bore defining a bore axis. The assembly further comprises a drive chamber in fluid connection with the bore, and one or more openings each providing a fluid connection between the bore and the drive chamber. The one or more openings each define an opening axis. The opening axis of each of the one or more openings is at least partially offset from the bore axis to introduce rotation of fluid in the drive chamber. The assembly further comprises a rotor rotatably mounted within the drive chamber. The rotor providing a fluid connection between the drive chamber and a tip on the rotor.

### TECHNICAL FIELD

This patent document relates to a spinner tip or nozzle for hydrovacing or for hydro blasting.

### BACKGROUND

Hydrovacing is a process for digging or excavating that involves using pressurized water to soften ground. Once the ground is softened, a vacuum system is used to remove the softened ground, thereby excavating the area. The pressurized water is provided by a pump system. The pump system may include a nozzle.

Hydro blasting is a method for cleaning various components. The cleaning is done to remove dirt, paint, or other layers from surfaces. The cleaning is performed by spraying high pressure water at the component. The pressurized water may be provided by a pump system. The pump system may include a nozzle.

Many current nozzle designs in these industries have various drawbacks, including not having rotatable nozzles or not having nozzles with adjustable rotation speeds.

### SUMMARY

An embodiment of a spinner tip is disclosed. The assembly comprises: an inlet having an inlet housing and a bore defining a bore axis; a drive chamber in fluid connection with the bore; one or more openings each providing a fluid connection between the bore and the drive chamber, the one or more openings each defining an opening axis, the opening axis of each of the one or more openings being at least partially offset from the bore axis to introduce rotation of fluid in the drive chamber; and a rotor rotatably mounted within the drive chamber, the rotor providing a fluid connection between the drive chamber and a tip on the rotor.

In various embodiments, there may be included any one or more of the following features: the one or more openings comprise a multi-helix cut; the one or more openings are formed on the drive chamber and provide inward spiral flow into the drive chamber during operation; the one or more openings in the drive chamber are inward tangential holes in the drive chamber; the drive chamber defines an inner drive circumference and the rotor defines an outer rotor circumference, and the inner drive circumference is greater than the outer rotor circumference so that the rotor rotates around the inner drive circumference due to rotation of the fluid in the drive chamber; an angle lock holding the rotor in a fixed axis of rotation within the drive chamber; a fluid bypass in fluid connection between the bore and the drive chamber; a needle arranged to move axially along the bore axis to adjust the amount of fluid passing through the fluid bypass; the rotor includes a plurality of vanes; a set screw on the inlet to adjust the amount of fluid passing through the fluid bypass; the one or more openings in the drive chamber are outward tangential holes in the inlet housing; the drive chamber further comprises an angle adjustment sleeve having a sloped internal surface for engagement against a side of the rotor and a lower housing for engagement with the tip of the rotor during operation of the spinner tip, and in which the angle adjustment sleeve and the lower housing are axially movable relative to each other to adjust the angle of the rotor within the drive chamber; a nozzle covering the tip and the nozzle comprising a relief port downstream of the tip; a seat on the drive chamber for contact against the tip during operation; an outer body, and the inlet housing is axially rotatable within the outer body, and axial rotation of the inlet housing within the outer body adjusts the amount of flow through the one or more openings; an outer body, and the inlet housing is axially rotatable within the outer body, and axial rotation of the inlet housing within the outer body adjusts the amount of flow through fluid bypass; and a plurality of detents and the spinner tip further comprising a ball spring mounted on the outer body, and the ball spring and detents providing tactile feedback of an amount of rotation between the outer body and the inlet housing.

An embodiment of a spinner tip is disclosed. The assembly comprises an inlet having an inlet housing and a bore defining a bore axis; a drive chamber in fluid connection with the bore; one or more openings each providing a fluid connection between the bore and the drive chamber, the one or more openings comprising inward tangential holes in the drive chamber and provide spiral flow into the drive chamber during operation; and a rotor rotatably mounted within the drive chamber, the rotor providing a fluid connection between the drive chamber and a tip on the rotor.

In various embodiments, there may be included any one or more of the following features: an inner drive circumference and the rotor defines an outer rotor circumference, and the inner drive circumference is greater than the outer rotor circumference so that the rotor rotates around the inner drive circumference due to rotation of the fluid in the drive chamber; a fluid bypass in fluid connection between the bore and the drive chamber; and the rotor includes a plurality of vanes.

These and other aspects of this technology are described herein.

### BRIEF DESCRIPTION OF THE FIGURES

Embodiments will now be described with reference to the figures, in which like reference characters denote like elements, by way of example, and in which:

FIG. 1 is a cross-section view of an embodiment of a spinner tip.

FIG. 2 is a side view of an embodiment of a spinner tip.

FIG. 3 is an isometric view of the embodiment of the spinner tip shown in FIG. 2.

FIG. 4 is an exploded view of the embodiment of the spinner tip shown in FIG. 2.

FIG. 5 is a cross-section view of a nozzle of the spinner tip shown in FIG. 2.

FIG. 6 is a side view of a rotor of the spinner tip shown in FIG. 2.

FIG. 7 is an isometric view of a rotor of the spinner tip shown in FIG. 2.

FIG. 8 is a cross-section view of the driver of the spinner tip shown in FIG. 2.

FIG. 9 is a cross-section view of the inlet housing of the spinner tip shown in FIG. 2.

FIG. 10 is a cross-section view of the embodiment the spinner tip in FIG. 2 with the rotor and front nozzle removed.

FIG. 11 is a cross-section view of an embodiment of a spinner tip with a needle to block openings and an angle adjustment sleeve.

FIG. 12 is a cross-section view of an embodiment of the spinner tip in FIG. 11 with an angle lock.

FIG. 13 is a cross-section view of an embodiment of a spinner tip with balls.

FIG. 14 is a cross-section view of an embodiment of a spinner tip with a port blocker.

FIG. 15 is a partial cross-section, isometric view of the spinner tip shown in FIG. 14.

FIG. 16 is a partial, isometric view of the spinner tip shown in FIG. 14.

FIG. 17 is a cross-section view of an embodiment of a spinner tip with a set screw for blocking a fluid bypass.

FIG. 18 is a cross-section view of an embodiment of a spinner tip with an alternative set screw for blocking a fluid bypass.

FIG. 19 is a cross-section view of an embodiment of a spinner tip with an outward spiral flow and a fluid chamber movable for fluid connection with a drive chamber.

FIG. 20 is a cross-section view of an embodiment of a spinner tip with a tab for flow control.

FIG. 21 is a cross-section view of an embodiment of a spinner tip with spray angle adjustment and a tab for flow control.

FIG. 22 is a cross-section view of an embodiment of a spinner tip with helical flow control.

### DETAILED DESCRIPTION

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

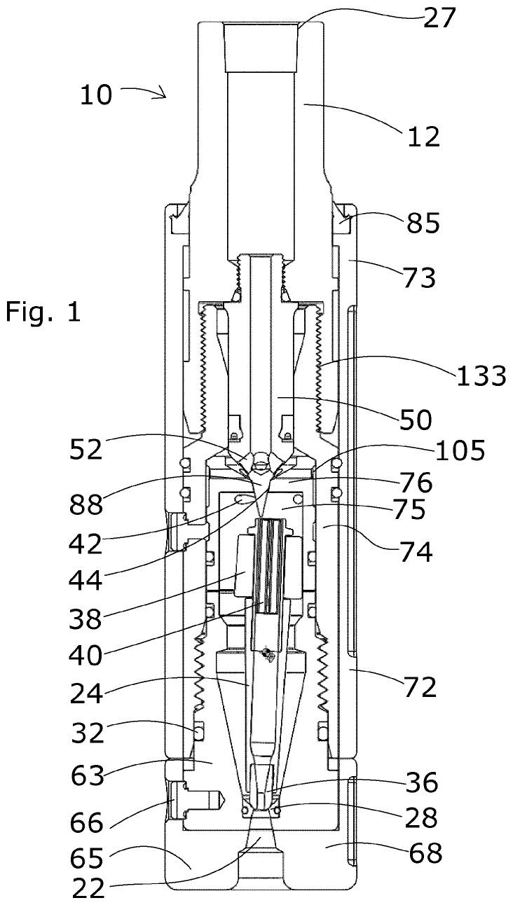

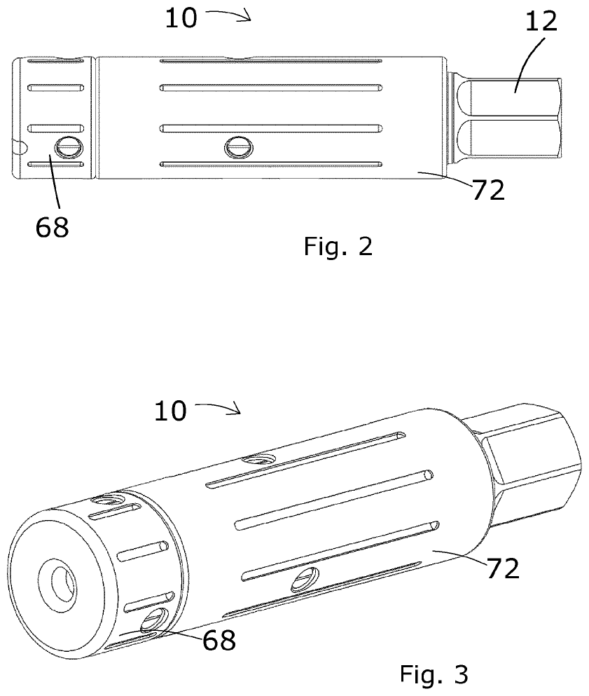

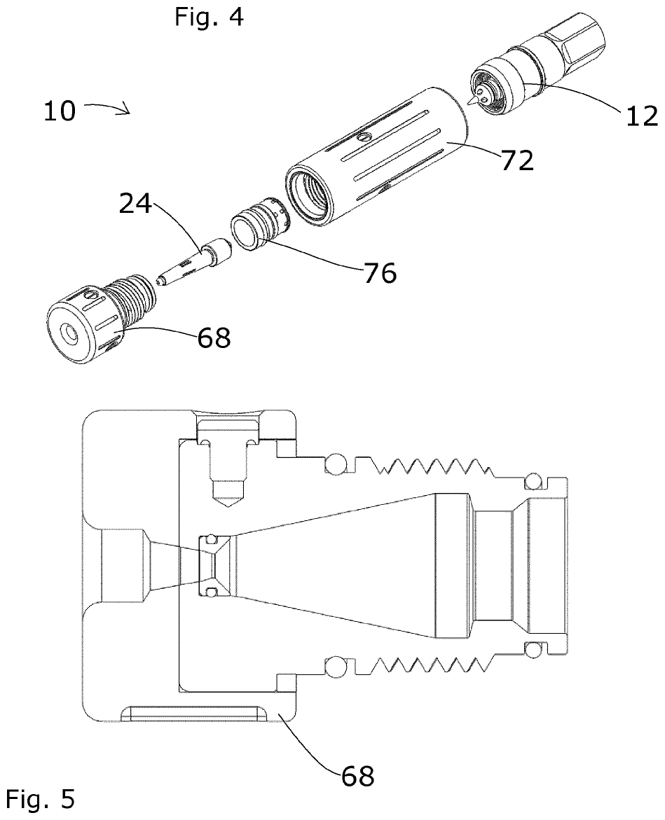

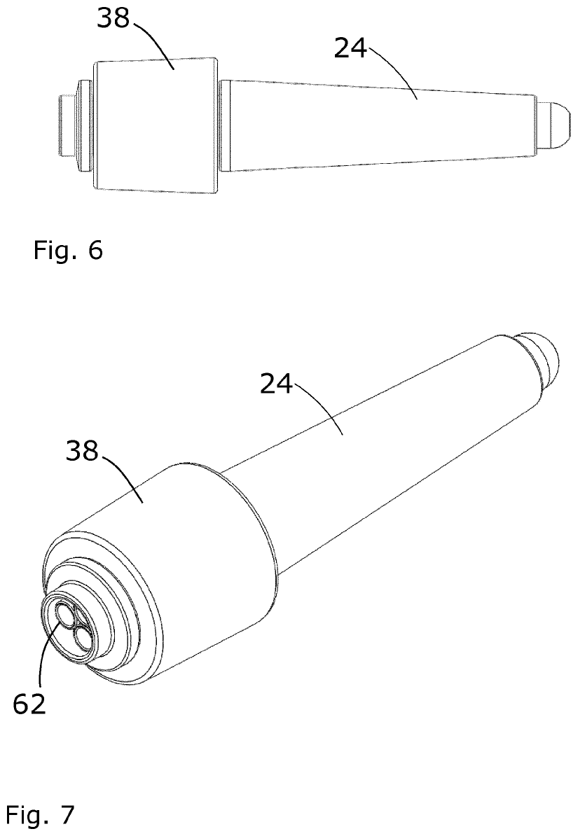

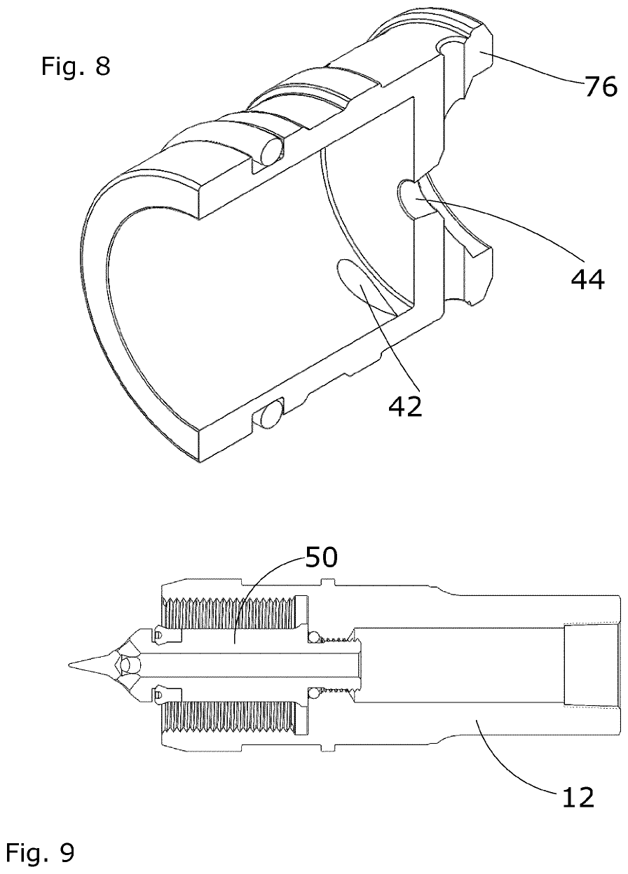

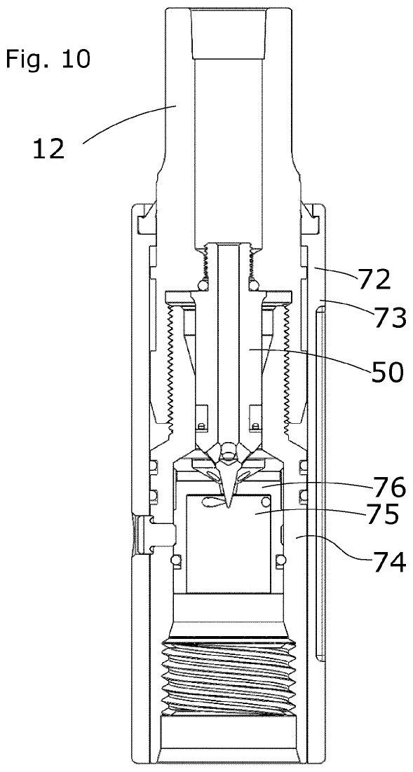

Referring to FIG. 1-10, an embodiment of a spinner tip 10 is shown. The spinner tip 10 comprises an inlet 72 having an inlet housing 12 and a bore 27 defining a bore axis. Fluid flows in through the inlet housing 12. The fluid may be water or other type of digging fluid or hydro blasting fluid. The inlet housing 12 may include a seal 85. The bore 27 may be for connecting a hose, tube, or pipe to provide fluid. The connection may be ½″ NPT or any other suitable connection.

The inlet 72 may further comprise an outer body 73, and the inlet housing 12 is axially rotatable within the outer body 73, and axial rotation of the inlet housing 12 within the outer body 73 adjusts the amount of flow through fluid bypass 44 or the openings 42. The spinner tip 10 may further comprise a needle 50 arranged to move axially along the bore 27 axis to adjust the amount of fluid passing through the fluid bypass 44 or through the one or more openings 42. The needle 50 may be fluidly connected to the inlet housing 12. The needle 50 may allow fluid to flow through it by a bore within the needle 50. The needle 50 may comprise a cone 88. The needle 50 may further comprise ports 52 fluidly connected to the bore within the needle 50. The ports 52 may be located on the sides of the needle 50. This assists with preventing flow blockage out of the needle 50.

The spinner tip 10 can function by reducing the velocity of fluid flowing through the openings 42 by bypassing a portion of the fluid through a fluid bypass 44. The spinner tip 10 may comprise the fluid bypass 44 in fluid connection between the bore 27 and the drive chamber 75. This allows for easily changing jet 22 flows and speeds as conditions change from jobsite to jobsite or even on the same job to maximize productivity. The fluid bypass 44 may be of any shape, number, or size that provides straight, non-circular, or non-spiral flow to the drive chamber 75. The fluid bypass 44 is optional and the spinner tip 10 may be used without the fluid bypass 44.

The fluid may flow from the ports 52 and into a fluid chamber 105. From the fluid chamber 105, the fluid flows through openings 42 within a driver 76. The openings 42 may be tangentially drilled and cause fluid to flow spirally in an axially inward direction into a drive chamber 75. The one or more openings 42 are formed on the drive chamber 75 and may provide inward spiral flow into the drive chamber 75 during operation. The one or more openings 42 in the drive chamber 75 may be inward tangential holes in the drive chamber 75. The drive chamber 75 is in fluid connection with the bore 27. The one or more openings 42 each providing a fluid connection between the bore 27 and the drive chamber 75. The one or more openings may each define an opening axis, the opening axis of each of the one or more openings 42 may be at least partially offset from the bore axis to introduce rotation of fluid in the drive chamber 75. Partially offset means that the axis of the openings 42 does not intersect the axis of the drive chamber 75. The offset can be between 1 degree to 89 degrees, with the greatest spiral flow created between 30-70 degrees. The one or more openings 42 may comprise a multi-helix cut. A multi-helix cut is a cut that could form part of a helical spiral with multiple helixes.

The amount of spiral flow through the openings 42 may be changed by adjusting the position of the needle 50. The needle 50 position is adjusted by rotating the inlet housing 12. The inlet housing 12 is connected to the needle 50 by threads or other appropriate means. The inlet housing 12 is also threaded 133 to an inner housing 74. The user may rotate the inlet housing 12. The inlet 72 may act as a grip so the user may turn a shaft which allows for adjustment of the needle 50 position. Rotation of the inlet housing 12 with respect to the inner housing 74 causes the cone 88 to move either towards or away from a fluid bypass 44, blocking or unblocking the port 44. When the needle 50 is moved away, the fluid bypass 44 opens, allowing for non-tangential or non-rotational fluid flow to enter the drive chamber 75. The needle ports 52 are in fluid communication with the fluid bypass 44 when open. The needle may be positioned within a range, allowing for fine control of the amount of tangential flow and non-tangential flow within the drive chamber 75.

A rotor 34 is rotatably mounted within the drive chamber 75. The rotor 24 provides a fluid connection between the drive chamber 75 and a tip 36 on the rotor. The rotor 24 rotates about its own axis as a result of the amount and speed of spiral flow within the drive chamber 75. The speed of the rotor 24 rotation is correlated with the amount and speed of spiral fluid entering the drive chamber 75 through the openings 42.

The driver 76 may be stainless steel or other suitable metal. The driver 76 may be thick, which allows for wear and long life. The driver 76 has one or more openings 42 and one or more fluid bypasses 44. The drive chamber 75 may be flooded. The main flow is never restricted, just redirected between the openings 42 and the fluid bypass 44 or both. This allows various rotors 24 to be used in the drive chamber 75, for example rotors ranging from 14 gpm to 46 gpm. Other flow rates are also available. The fluid bypass 44 can be fully blocked, in which case all flow travels through the openings 42 to cause the rotor 24 to rotate at a faster pace than if the fluid bypass 44 is open. When all flow travels through the openings 42, the rotor 24 may move at 3000 rpm. When all fluid flow travels through the openings 42, all of the drive force moves through the openings 42. To slow the rotor 24 down for better digging, the fluid bypass 44 may be opened so that less flow moves through the openings 42 and more flow moves through the fluid bypass 44. When the fluid bypass 44 is opened, there is less driving force because less fluid flows through the openings 42. The fluid bypass 44 does not cause rotation of the rotor 24. The openings 42 cause rotation of the rotor 24. The amount of flow through the ports may be adjusted easily between the openings 42 and fluid bypass 44 by screwing the inlet housing 12.

The drive chamber 75 defines an inner drive circumference and the rotor 24 defines an outer rotor circumference, and the inner drive circumference is greater than the outer rotor circumference so that the rotor 24 rotates around the inner drive circumference due to rotation of the fluid in the drive chamber 75. The roller 38 may be in any appropriate shape that allows it to rotate within the drive chamber 75. The rotor 24 may rotate about its own axis or the rotor may rotate along the circumference of the drive chamber 75 or the rotor may rotate in both manners simultaneously. The rotor 24 may comprise a roller 38. The roller 38 may comprise bearings, rubber rings, O-rings, or carbide coatings or other coatings for wear and may be made from plastic, metal or other suitable wear material. The roller 38 sits loosely within the drive chamber 75. The gap between the drive chamber 75 bore and the roller 38 outer diameter causes the roller 38 to change the angle of co-axial alignment between the rotor 24 axis and the drive chamber 75 bore axis. The gap size can be modified by modifying the size of the drive chamber 75 bore or the roller 38. The roller 38 size and shape may also be modified to change the spray angle. The angle of coaxial alignment between the rotor 24 axis and the driver 76 axis defines the spray angle 502. The roller 38 rolls around the circumference of the driver 76 bore as a result of the flow within the drive chamber 75.

The fluid within the drive chamber 75 may enter the rotor 24 through bores 62 in the top of the rotor 24. The rotor 24 may include a plurality of vanes 40. Fluid flowing through the rotor 24 may be straightened via vanes 40. A tip 36 within the rotor 24 may act like a venturi device to assist with flow control and dynamics.

The spinner tip 10 may further comprise a seat 28 on the drive chamber 75 for contact against the tip 36 during operation. The tip 36 sits on a seat 28. The seat 28 and the tip 36 may be made from any material that prevents wear, including carbide or bronze. The rotor 24 may convert any of the different spray angles to a straight jet configuration.

Additionally, inside the rotor 24, there may also be a taper venturi type switch, which uses fluid dynamics, to ensure the flow is correct before it reaches the tip 36. The rotor 24 gives a solid stream of fluid.

The rotor 24 is forced towards the seat 28 side of the drive chamber 75 by fluid flow. The fluid force in the drive chamber keeps the tip 36 against the seat 28.

The fluid flows from the tip 36 and seat 28 and out of the jet 22.

The spinner tip 10 may also include O-rings 32 at various locations for sealing fluid and debris. The spinner tip 10 may include an inlet 72 for securing and protecting components. The spinner tip 10 may also include plugs 66 which may be removed and replaced to allow for assembly and disassembly of the spinner tip 10. When the plugs 66 are removed, the components of the spinner tip 10 may slide out of the inlet 72. The plugs 66 may be screws or snap type connectors. The plugs 66 may be rivet type connectors.

The inlet housing 12 is threaded to an inner housing 74 which is threaded to a lower housing 63. The lower housing 63 is held in place by plugs 66 within a nozzle 68.

In this design, the openings 42 are on the outside wall of the driver 76. In the current embodiment, the fluid sprays inwards towards the inner axis into the driver 76. The rotor 24 can convert any of the different spray angles to a straight jet configuration. The spinner tip 10 may comprise a nozzle 68 covering the tip 36 and the nozzle 68 comprising a relief port 65 downstream of the tip 36. The relief ports 65 reduce blow back into the spinner tip 10 for prolonging the service life.

The spinner tip 10 may be disassembled and the rotor 24 may be removed as shown in FIG. 4. The rotor 24 may be replaced as required or a selection of rotor gallons per minute (“gpm”) can be selected to do specific jobs. The rotor's gpm may be modified by changing the size or shape of the rotor's bores, vanes, roller, or venturi tip device.

The spinner tip 10 is described herein as having two main components: an inlet 72, which takes in fluid, and a drive chamber 75, which drives and contains the rotor 24. The drive chamber 75 could be any number of components together or separate, threaded, connected or otherwise that move fluid in a spiral or circular manner and causes the rotor 24 to rotate within a drive chamber 75. The inlet 72 could comprise any number of components, including various housings, that transfer fluid to the drive chamber 75.

The one or more openings 42 could have any number of shapes that create spiral, circular, or tangential flow within the drive chamber 75. The openings 42 could be placed within the driver 76, inlet housing 12, or could be placed elsewhere that allows flow to enter the drive chamber 75. The drive chamber 75 could have various angles, length, or be made up of various components as long as rotation within the drive chamber 75 is achieved. The rotor 24 may have various shapes or sizes as long as it rotates within the drive chamber 75. The rotor 24 may be pushed into position towards the nozzle 68 side of the spinner tip 10 within the drive chamber 75 by fluid pressure moving through the spinner tip 10 or could be held in this position by a connector. The openings 42 could also cause fluid to flow diametrically outwards into the drive chamber 75 or flow diametrically inwards into the drive chamber 75.

The flow bypass 44 could be blocked in any appropriate manner that allows throttling of the fluid bypass 44.

Various other embodiments of the spinner tip 10 are described in the following figures. These figures include features which have various similarities to those as shown in FIGS. 1-10, many of which are not explicitly described but will be understood by the person skilled in the art. The differences between the embodiments discussed below and the embodiment in FIG. 1-10 are described in the following paragraphs. Various features of the different embodiments may be combined or removed in the features of other embodiments, so long as the design features are not incompatible.

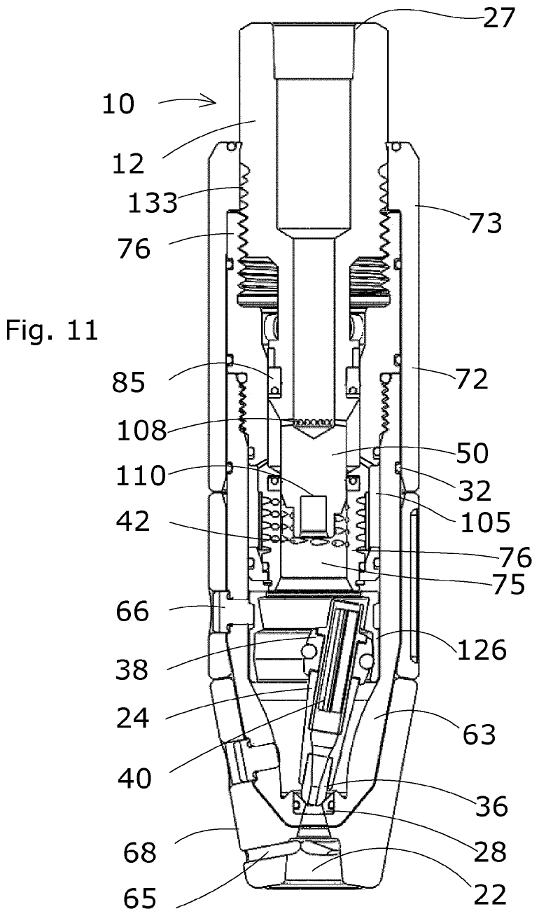

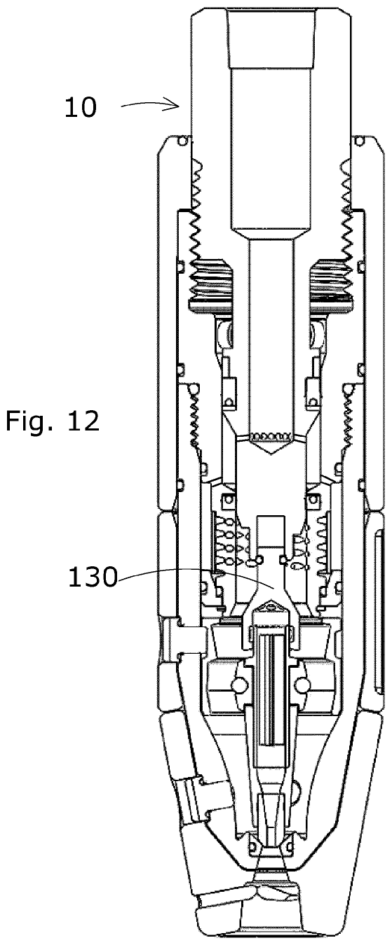

Referring to FIGS. 11-12, an embodiment of a spinner tip 10 is shown. In the embodiment the inlet housing 12 includes a needle 50. The needle 50 includes side bores 108 that allow fluid to exit the rod. The side bores 108 are in fluid communication with a fluid chamber 105. The fluid may exit the fluid chamber 105 through openings 42 in a driver 76 which is part of the drive chamber 75.

The openings 42 are tangentially drilled and cause fluid to flow spirally or tangentially within the driver 76. The amount of spiral flow may be reduced by adjusting the position of the needle 50. The needle 50 position is adjusted by rotating the inlet housing 12. The inlet housing 12 is connected to the needle 50. Rotation of the inlet housing 12 causes the needle 50 to move axially with respect to the driver 76. The user may rotate the inlet housing 12 to make the adjustments.

The embodiment allows for adjustable speed. This occurs by reducing the velocity flowing through openings 42 by opening more openings 42. When more openings 42 are opened, there is slower flow velocity through the openings 42. This allows for easily changing the rotation speed of the fluid exiting the jet 22 as conditions change from jobsite to jobsite or even on the same job to maximize productivity. This speed adjustment allows for the rotor 24 to be changed to facilitate the changing of fluid output flows as conditions change. The speed adjustment also allows for speed adjustments to compensate for changes in operating pressures which are required depending on the type of infrastructure being exposed and the client's preferences. In the past, a lower operating pressure resulted in a slower rotating speed which could not be adjusted externally.

The spinner tip 10 may further comprise an angle lock 130 holding the rotor 24 in a fixed axis of rotation within the drive chamber 75. The needle 50 may include a center housing 110. The center housing 110 may be used as a housing to hold an angle lock 130. The angle lock 130 holds the rotor 24 in position so that the rotor 24 is in coaxial alignment with the axis of the bore of the driver 76. Other alignments are available for the angle lock 130. The angle lock 130 allows the rotor to rotate and may include seals on either end. The angle lock 130 may include a bore that allows flow to communicate with the driver 76 and the rotor 24. The angle lock 130 may be removable as the user requires. The angle lock 130 may be made to allow or not allow rotation of the rotor 24 about its own axis.

The roller 38 sits loosely within an angle adjustment sleeve 126 inner bore. By doing so, the rotor 24 may change its angle of co-axial alignment with respect to the driver 76 axis. The angle adjustment sleeve 126 inner bore may be smaller or larger in diameter which controls how loosely the rotor 24 sits within the angle adjustment sleeve 126. The angle adjustment sleeve 126 can be replaced with other shapes or sizes to allow for the changing of the spray angle in addition to the changing of the rotating speed for maximum versatility. The angle adjustment sleeve 126 may be made from any suitable wear material, including metal or plastic. The angle adjustment sleeve 126 may be made movable along the axis of the driver chamber 75 to change the spray angle. The roller 38 may also rotate or roll around the circumference of the angle adjustment sleeve 126 as a result of the flow.

The angle adjustment sleeve 126 may be located within the lower housing 63 which may be connected to the driver 76 via threads. The lower housing 63 may be located within the nozzle 68, and the angle adjustment sleeve 126 may be located within the lower housing 63. The angle adjustment sleeve 126 may be held in the lower housing 63 with a plug 66. The nozzle 68 may be held to the lower housing 63 with a plug 66.

The fluid within the drive chamber 75 and angle adjustment sleeve 126 enters the rotor 24 at one end.

In the embodiment shown, the openings 42 are on the outside wall of the driver 76. In the current embodiment, the fluid sprays inwards through the openings 42 towards the inner axis of the driver 76.

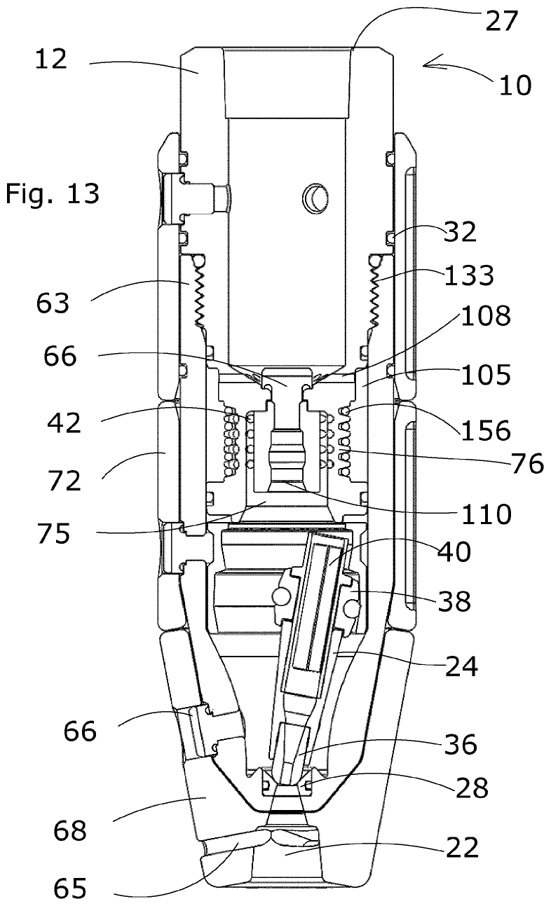

Referring to FIG. 13, an embodiment of a spinner tip 10 is shown. The inlet housing 12 may be located within a lower housing 63 and may be connected via threads.

The inlet housing 12 includes side bores 108. The bores are in fluid communication with a fluid chamber 105. The fluid exits the fluid chamber 105 through openings 42 into a drive chamber 75.

The inlet housing 12 may include a plug 66 which may be removed or adjusted to allow non-rotational flow into the drive chamber 75 and thereby act as a fluid bypass 44. The plug 66 may also be fully closed to prevent flow through the plug 66 hole. Alternatively, the plug 66 hole in the inlet housing 12 may not be included whatsoever and be closed with material.

The openings 42 are tangentially drilled and cause fluid to flow spirally or tangentially within the drive chamber 75. The speed of spiral flow may be increased by blocking the openings 42 with balls 156. The speed of the fluid flow into the drive chamber 75 may be decreased by removing balls 156 that are blocking the openings 42. The balls 156 may be metal balls. The number of balls 156 may be added or removed with the spinner tip 10 disassembled.

A center housing 110 may be included which can hold an angle lock 130. The angle lock 130 may be removable as the user requires.

The adjustable spinner 306 may include threads 133 for making connections or adjustments and O-rings 32 for sealing.

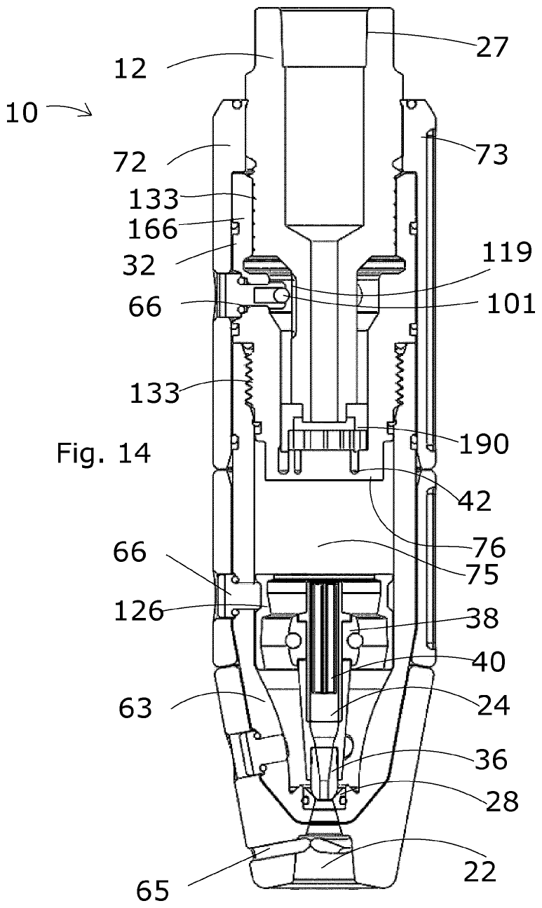

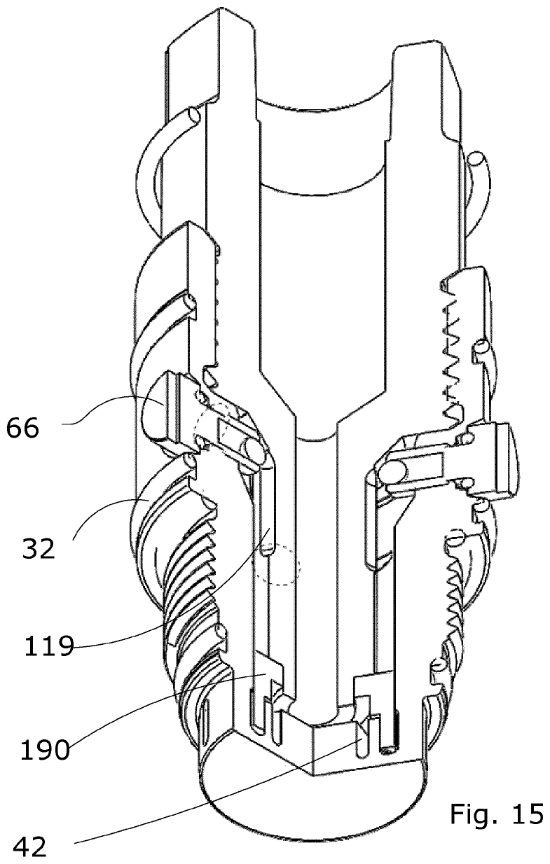

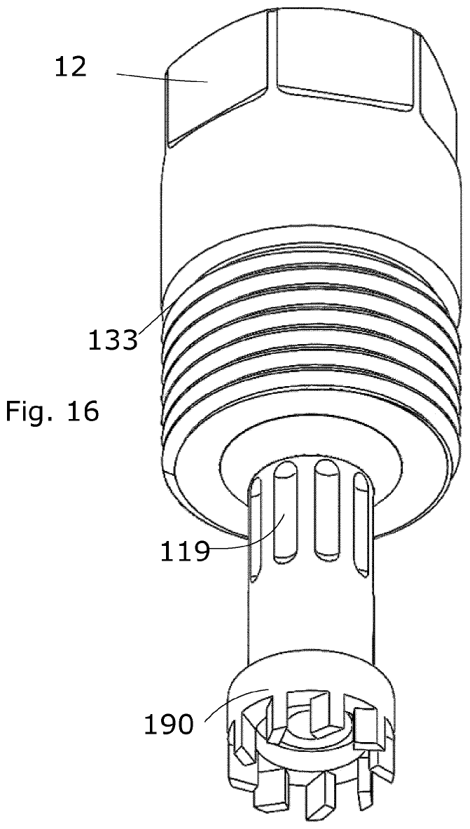

Referring to FIGS. 14-16, an embodiment of a spinner tip 10 is shown. In the embodiment, the fluid enters the inlet housing 12 and is in communication with openings 42 located within a driver 76. The openings 42 are cut into the upper housing 166 tangentially. This causes fluid to flow spirally or tangentially into the drive chamber 75.

A port blocker 190 is connected to the inlet housing 12. The port blocker 190 may slide into the openings 42 to block flow through openings 42. The speed of the flow may be increased by blocking more of the openings 42. The speed of the flow may be decreased by blocking less of the openings 42 with the port blocker 190.

The amount of spiral flow may be reduced by adjusting the position of port blocker 190. The port blocker 190 is moved axially to block the openings 42 via rotation of the inlet housing 12 with respect to the upper housing 166. The upper housing 166 and inlet housing 12 are threaded 133. The upper housing 166 may be held in place by threading 133 to a lower housing 63.

The user may rotate the inlet housing 12 to make the adjustments. The inlet 12 may further comprise a plurality of detents 119 and the spinner tip 10 may further comprise a ball spring 101 mounted on the outer body 73, and the ball spring 101 and detents 119 providing tactile feedback of an amount of rotation between the outer body 73 and the inlet housing 12. When rotating, there may be detents 119 included so the user is aware of the position of the port blocker 190. The detents are connected to plugs 66 which may be screws or other rivet type connectors. The plugs 66 may include a ball spring 101. The ball spring 101 sits in the detent 119 to notify the user of the position of the rotation. The ball spring 101 moves out of the detent 119 and into the next detent 119 as the user adjusts. When the port blocker 190 moves axially, openings 42 may become blocked or opened by the port blocker 190 sliding inside the openings 42.

The speed of the flow into the lower housing 63 through the openings 42 functions by reducing the velocity flowing through the openings 42 by opening the openings 42 more. The openings 42 may be in the form of slots.

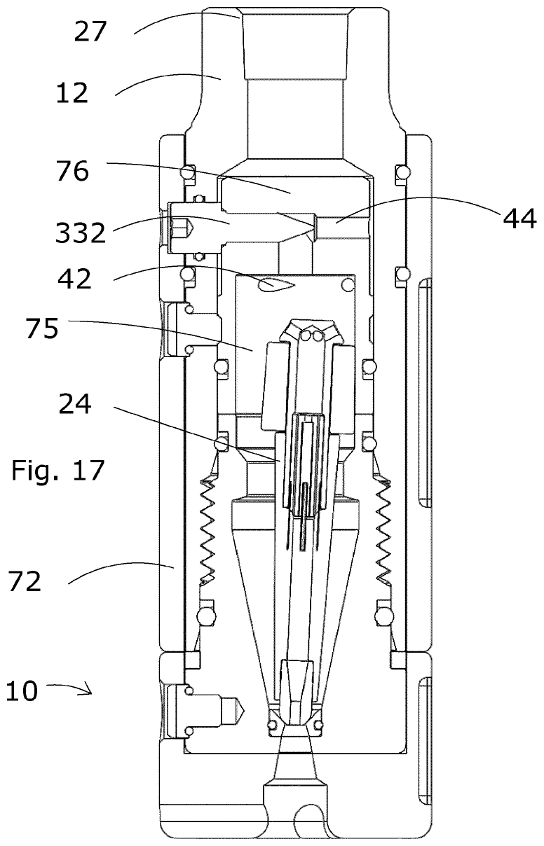

Referring to FIG. 17, an embodiment of spinner tip 10 is shown. In the embodiment, fluid flows in one end of an inlet housing 12. The fluid flows through the fluid bypass 44 and the openings 42. The inlet 72 may further comprise a screw 332 on the inlet 72 to adjust the amount of fluid passing through the fluid bypass 44. The fluid bypass 44 may be blocked by a screw 332. The screw 332 may be adjusted by the user to adjust the position of the blocking tip of the screw 332. The screw 332 may be any appropriate type, including a set screw. By adjusting the amount of fluid flowing through the fluid bypass 44, the amount of flow through the openings is also adjusted 42. The flow through the openings 42 causes tangential or spiral flow to enter the drive chamber 75, whereas the flow through the fluid bypass 44 causes straight or non-circular flow to enter the drive chamber 75. The rotor 24 rotation and rolling speed is adjusted by modifying the amount of spiral or straight flow in the drive chamber 75.

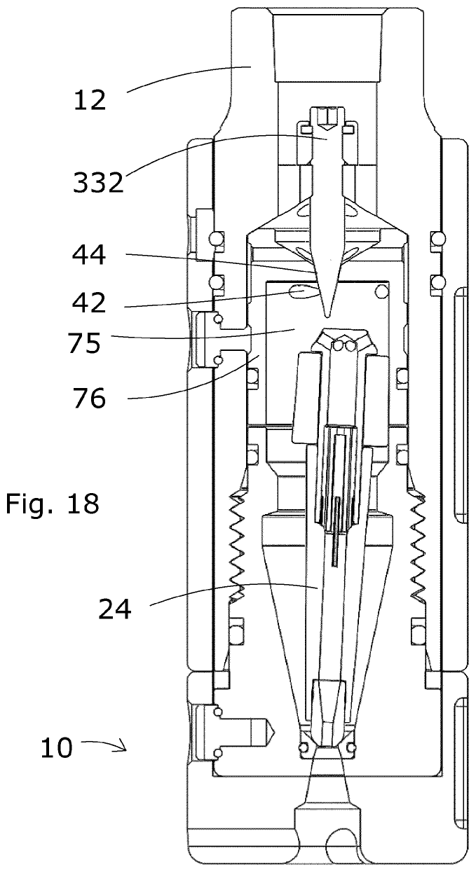

Referring to FIG. 18, an embodiment of a spinner tip 10 is shown. In the embodiment, fluid flows into the inlet housing 12. The fluid flows through a fluid bypass 44 and openings 42. The fluid bypass 44 may be blocked by a screw 332. The screw 332 may be adjusted by the user to adjust the position of the blocking tip of the screw 332. By adjusting the amount of fluid flowing through the fluid bypass 44, the amount of flow through the openings is also adjusted 42. Less flow through the fluid bypass 44 causes more flow through the openings 42. The flow through the openings 42 causes tangential, spiral, or circular flow to enter the drive chamber 75, whereas the flow through the fluid bypass 44 causes straight or non-circular flow to enter the drive chamber 75. The rotor 24 rotation and rolling speed is adjusted by modifying the amount of spiral or straight flow from the driver 76.

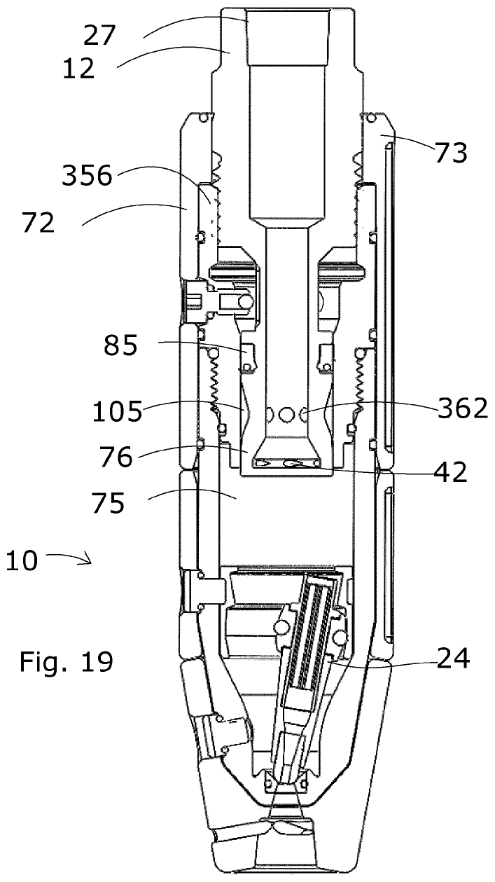

Referring to FIG. 19, an embodiment of a spinner tip 10 is shown. In the embodiment, fluid flows into the inlet housing 12. The fluid then flows through inner bores 362 to a fluid chamber 105. The fluid chamber 105 may be either opened or closed to the drive chamber 75. The amount that the fluid chamber 105 is opened to the drive chamber 75 is adjustable and controls the amount of straight, non-circular flow entering the drive chamber 75. When the fluid chamber 105 is directly opened to the drive chamber 75 in this way, it acts as a fluid bypass 44. The fluid chamber 105 is opened or closed to the drive chamber 75 by moving the inlet housing 12 axially by screwing the inlet housing 12 which is threaded to the upper housing 356. By screwing the inlet housing 12, the gap amount between the fluid chamber 105 and the drive chamber 75 is adjusted.

The fluid also flows into openings 42 through the inlet housing 12 bore. The openings 42 cause spiral or tangential flow into the drive chamber 75. The one or more openings 42 in the drive chamber 75 are outward tangential holes in the inlet housing 12. The openings 42 could be included on any other components that allow flow to enter the drive chamber 75.

By adjusting the amount of fluid flowing through the fluid chamber 105, the amount of flow through the openings 42 is also adjusted. Less flow through the fluid chamber 105 causes more flow through the openings 42. The flow through the openings 42 causes tangential or spiral flow to enter the drive chamber 75, whereas the flow through the fluid chamber 105 causes straight or non-circular or non-spiral flow to enter the drive chamber 75. The rotor 24 rotation and rolling speed is adjusted by modifying the amount of spiral or straight flow in the drive chamber 75.

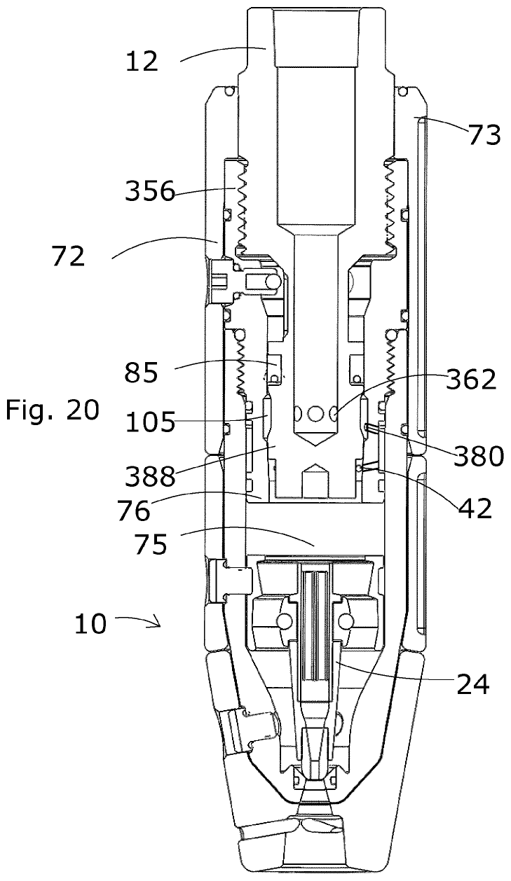

Referring to FIG. 20, an embodiment of a spinner tip 10 is shown. In the embodiment, fluid flows in one end of an inlet housing 12. The fluid flows through inner bores 362 to a fluid chamber 105. The fluid chamber 105 may be either opened or closed to the drive chamber 75. The amount that the fluid chamber 105 is opened to the drive chamber 75 is adjustable and controls the amount of straight, non-rotational flow entering the drive chamber 75. The fluid chamber 105 is opened or closed to the drive chamber 75 by moving the inlet housing 12 axially by screwing the inlet housing 12 which is threaded to the upper housing 356. When opening the fluid chamber 105, a tab 388 is moved into the fluid chamber 105 which allows the fluid to flow directly into the drive chamber 75 without flowing through the inner port 380. When the fluid chamber 105 is directly opened to the drive chamber 75 in this way, it acts as a fluid bypass 44. The amount the fluid chamber 105 is opened or closed can be throttled.

When the fluid chamber 105 is closed as shown, the fluid flows only through the inner port 380 and then through the openings 42. The openings 42 cause spiral or tangential flow into the drive chamber 75. By adjusting the amount the fluid chamber 105 is opened to the drive chamber 75, the amount of flow through the openings 42 is also adjusted. Less flow through the fluid chamber 105 directly into the drive chamber 75 causes more flow through the inner ports 380 and then the openings 42. The flow through the openings 42 causes tangential or spiral flow to enter the drive chamber 75, whereas the flow directly through the fluid chamber 105 and into the drive chamber 75 causes straight or non-circular flow to enter the drive chamber 75. The rotor 24 rotation and rolling speed is adjusted by modifying the amount of spiral or straight, non-rotational flow in the drive chamber 75.

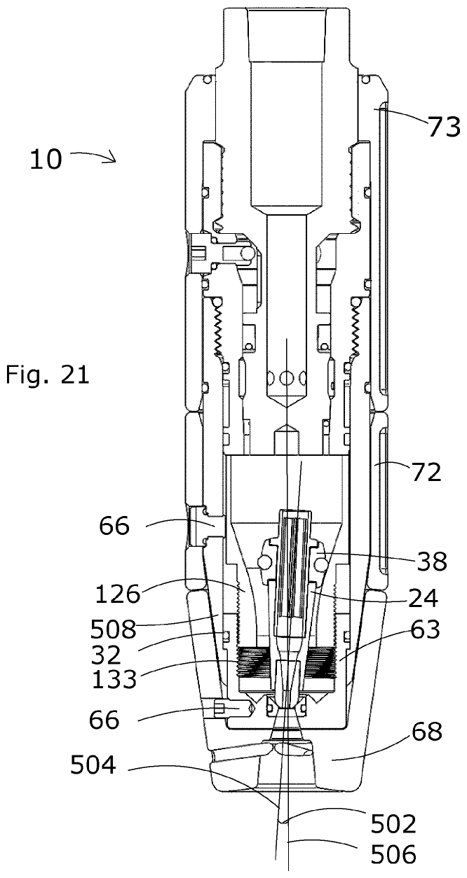

Referring to FIG. 21, an embodiment of a spinner tip 10 is shown. In the embodiment, an angle adjustment sleeve 126 is shown. The drive chamber 75 may further comprise an angle adjustment sleeve 126, having a sloped internal surface for engagement against a side of the rotor 24 and a lower housing 63 for engagement with the tip 36 of the rotor 24 during operation of the spinner tip 10, and in which the angle adjustment sleeve 126 and the lower housing 63 are axially movable relative to each other to adjust the angle of the rotor 24 within the drive chamber 75.

The angle adjustment sleeve 126 is threaded 133 to a lower housing 63. The angle adjustment sleeve 126 may be rotated relative to the lower housing 63 to move the angle adjustment sleeve 126 axially away or towards the lower housing 63. By adjusting the position of the angle adjustment sleeve 126 in this manner, the spray angle 502 of coaxial alignment between the rotor axis 504 and the drive chamber axis 506 may be adjusted. Movement of the angle adjustment sleeve 126 away from the lower housing 63 reduces the spray angle 502. The roller 38 moves into a position where it rolls on a narrower bore of the angle adjustment sleeve 126 because of the angle adjustment sleeve's 126 bore taper. As the angle adjustment sleeve 126 moves, its taper forces the rotor 24 closer to the drive chamber axis 506. This allows adjustment between an angled rotating spray to a straight 0° non-rotating or rotating spray.

Conversely, the spray angle 502 may be made larger by adjusting the angle adjustment sleeve 126 towards the lower housing 63. In doing so, the roller 38 rolls on a larger bore circumference of the angle adjustment sleeve 126, which causes a larger spray angle 502. The spray angle 502 may be adjusted between 0 degrees and any angle supportable by the geometry, for example 30 degrees or greater.

Any shape or slope of angle adjustment sleeve 126 may be used that allows for the spray angle 502 to be modified in this manner.

The lower housing 63 may be rotated by rotating the nozzle 68 which is connected to the lower housing 63 via a plug 66. The plug 66 may be a screw or other suitable connection type.

The angle adjustment sleeve 126 is held in place via a plug 66, which may be a screw or other suitable connection type. The plug 66 connects to the angle adjustment sleeve 126 to hold it in place.

Lower housing 63 and upper housing 508 may slide with respect to one another as required for the movement of the angle adjustment sleeve 126. An O-ring 32 may be included between the lower housing 63 and the upper housing 508. The O-ring 32 provides a fluid seal and keeps the nozzle 68 in its rotated adjustment position by friction. Ball spring 101 and detents 119 may also be used to keep the nozzle 68 in the rotated position. The ball spring 101 may be installed in inlet 72 with the detents 119 in the nozzle 68.

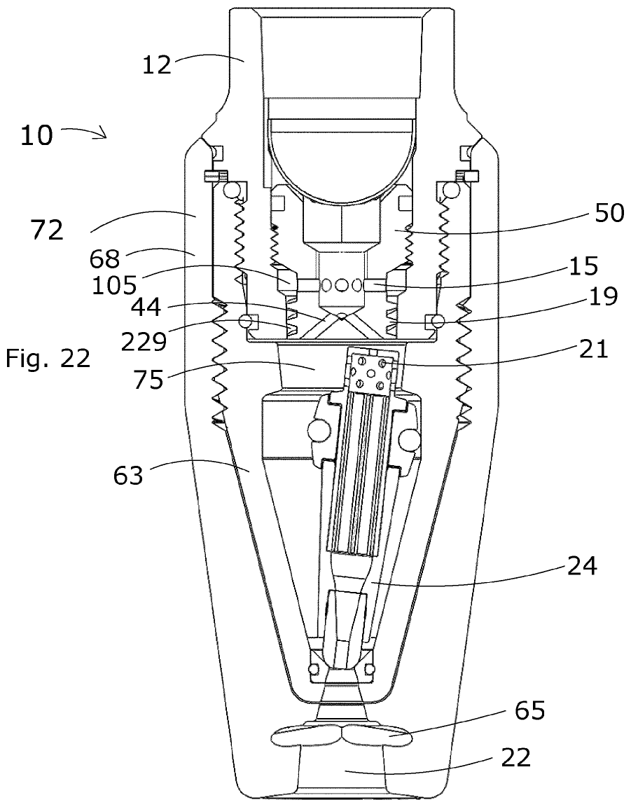

Referring to FIG. 22, an embodiment of a spinner tip 10 is shown. The fluid enters the inlet housing 12. The inlet housing 12 is fluidly connected to a needle 50. The needle 50 may include ports 15 that allow fluid to pass from the needle 50 into a fluid chamber 105. The needle 50 may include threads 19. The fluid in the chamber 105 flows over the threads 19, creating a spiraling motion of the fluid. The flow over the threads 19 may act as openings 42. The spinning or spiraling fluid then enters the drive chamber 75 where the fluid spins the rotor 24. The drive chamber 75 may be formed within the lower housing 63.

The fluid in the drive chamber 75 may enter the rotor 24 by holes 21. The holes 21 help to reduce the turbulence of the fluid within the rotor 24 by creating a space of calmer fluid within the rotor 24. The fluid then exits the rotor 24 creating a jet 22.

The needle 50 may also include fluid bypass 44. The fluid bypass 44 does not cause spiral flow into the drive chamber 75. Straight fluid flow flows through the fluid bypass 44 into the drive chamber 75.

The amount of spiral flow in the drive chamber 75 may be adjusted by the needle position 50. The needle 50 may be screwed and shifted axially relative to the inlet housing 12. By doing so, the number of threads 19 may be increased or reduced that contact the fluid in the narrow portion 229 of the fluid chamber 105. The number of threads 19 that contact the fluid in this region is correlated to an increase or decrease in the rotation speed of the fluid in the drive chamber 75.

Immaterial modifications may be made to the embodiments described here without departing from what is covered by any claims.

1. A spinner tip, comprising:
an inlet having an inlet housing and a bore defining a bore axis;
a drive chamber in fluid connection with the bore;
one or more openings each providing a fluid connection between the bore and the drive chamber, the one or more openings each defining an opening axis, the opening axis of each of the one or more openings being at least partially offset from the bore axis to introduce rotation of fluid in the drive chamber; and
a rotor rotatably mounted within the drive chamber, the rotor providing a fluid connection between the drive chamber and a tip on the rotor.

2. The spinner tip of claim 1 in which the one or more openings comprise a multi-helix cut.

3. The spinner tip of claim 1 in which the one or more openings are formed on the drive chamber and provide inward spiral flow into the drive chamber during operation.

4. The spinner tip of claim 3 in which the one or more openings in the drive chamber are inward tangential holes in the drive chamber.

5. The spinner tip of claim 1 in which the drive chamber defines an inner drive circumference and the rotor defines an outer rotor circumference, and the inner drive circumference is greater than the outer rotor circumference so that the rotor rotates around the inner drive circumference due to rotation of the fluid in the drive chamber.

6. The spinner tip of claim 1 further comprising an angle lock holding the rotor in a fixed axis of rotation within the drive chamber.

7. The spinner tip of claim 1 further comprising a fluid bypass in fluid connection between the bore and the drive chamber.

8. The spinner tip of claim 7 in which the inlet further comprises a needle arranged to move axially along the bore axis to adjust the amount of fluid passing through the fluid bypass.

9. The spinner tip of claim 1 in which the rotor includes a plurality of vanes.

10. The spinner tip of claim 7 in which the inlet further comprises a set screw on the inlet to adjust the amount of fluid passing through the fluid bypass.

11. The spinner tip of claim 3 in which the one or more openings in the drive chamber are outward tangential holes in the inlet housing.

12. The spinner tip of claim 1 in which the drive chamber further comprises an angle adjustment sleeve having a sloped internal surface for engagement against a side of the rotor and a lower housing for engagement with the tip of the rotor during operation of the spinner tip, and in which the angle adjustment sleeve and the lower housing are axially movable relative to each other to adjust the angle of the rotor within the drive chamber.

13. The spinner tip of claim 1 further comprising a nozzle covering the tip and the nozzle comprising a relief port downstream of the tip.

14. The spinner tip of claim 1 further comprising a seat on the drive chamber for contact against the tip during operation.

15. The spinner tip of claim 1 in which the inlet further comprises an outer body, and the inlet housing is axially rotatable within the outer body, and axial rotation of the inlet housing within the outer body adjusts the amount of flow through the one or more openings.

16. The spinner tip of claim 7 in which in which the inlet further comprises an outer body, and the inlet housing is axially rotatable within the outer body, and axial rotation of the inlet housing within the outer body adjusts the amount of flow through fluid bypass.

17. The spinner tip of claim 15 in which the inlet further comprises a plurality of detents and the spinner tip further comprising a ball spring mounted on the outer body, and the ball spring and detents providing tactile feedback of an amount of rotation between the outer body and the inlet housing.

18. A spinner tip, comprising:
an inlet having an inlet housing and a bore defining a bore axis;
a drive chamber in fluid connection with the bore;
one or more openings each providing a fluid connection between the bore and the drive chamber, the one or more openings comprising inward tangential holes in the drive chamber and provide spiral flow into the drive chamber during operation; and
a rotor rotatably mounted within the drive chamber, the rotor providing a fluid connection between the drive chamber and a tip on the rotor.

19. The spinner tip of claim 17 in which the drive chamber defines an inner drive circumference and the rotor defines an outer rotor circumference, and the inner drive circumference is greater than the outer rotor circumference so that the rotor rotates around the inner drive circumference due to rotation of the fluid in the drive chamber.

20. The spinner tip of claim 17 further comprising a fluid bypass in fluid connection between the bore and the drive chamber.

21. The spinner tip of claim 17 in which the rotor includes a plurality of vanes.
